(19) United States
(12) Patent Application Publication
(10) Pub. No.: US 2014/0258718 A1
(43) Pub. Date: Sep. 11, 2014

(54) METHOD AND SYSTEM FOR SECURE TRANSMISSION OF BIOMETRIC DATA

(71) Applicant: ASYMPTOTE SECURITY LLC, Northhampton, MA (US)

(72) Inventor: Devon ISAKOW, Northhampton, MA (US)

(73) Assignee: ASYMPTOTE SECURITY LLC, Northhampton, MA (US)

(21) Appl. No.: 14/197,456

(22) Filed: Mar. 5, 2014

Related U.S. Application Data
(60) Provisional application No. 61/774,076, filed on Mar. 7, 2013.

(51) Int. Cl. H04L 29/06

(52) U.S. Cl. CPC H04L 63/0428
USPC 713/165

(57) ABSTRACT

The invention relates to a system (100) for securing the transmission of biometric data over an insecure network (16). The system (100) includes a transaction terminal (18) having a user interface (28, 30), a biometric scanner (26), and a communication interface (24) for transmitting and receiving data to and from a processing unit (19) over the network (16). The terminal (18) has a unique serial number (400) and a unique private key. The system (100) includes a secure database (10), to which the processing unit (19) is connected, for storing personal identification information and biometric templates of users, and the serial number (400) and associated private key of the terminal (18). The terminal (18) receives identification information and biometric data via the user interface (28, 30) and scanner (26), and generates a unique transaction code (402). The terminal (18) then generates a hash of the received identification information, biometric data and transaction code (402), and encrypts the hash using the key. The terminal (18) then sends the encrypted data over the network (16) to the processing unit (19).

### BACKGROUND OF THE INVENTION

THIS invention relates to a method and a system for secure transmission of data, particularly biometric data used to secure access to sensitive information.

The protection of personal information such as passwords or PINs is difficult as secure user names and passwords are easy to forget or lose, and if they are not then they are easily computed by a computer using a brute force attack. Various methods are used continually in attempts to access financial information of individuals for fraudulent purposes.

Even if an individual keeps his or her personal data secure, other people or companies with access to the data may not do so, which puts the individual at risk. For example, retailers commonly store the credit card information of customers. Hacking of such data is quite common. It is even known for the issuers of security methods themselves to fall prey to hackers (for example, the RSA was fooled by a social networking scam that potentially compromised the security of all “secure-id” tokens).

As a result of such ongoing threats, increasingly stringent measures are being adopted by banks, retailers and other organizations regarding security. This may involve the use of multiple passwords, one time passwords, and other techniques. One approach to increasing the security of sensitive data, such as banking data or other financial data, is to require the use of hardware tokens which generate the necessary security codes. An alternative approach is to use biometric data, such as fingerprint or iris scan data, in place of conventional PINs or passwords.

Since biometric “matches” are never exact, unlike like PINs or passwords, matches occur if the scanned biometric data falls within a certain threshold of a template. This makes it difficult to use the usual encryption or hashing algorithms used for PINs or passwords, as the nature of the algorithms prevents us from knowing the “difference” between the template and the sample for matching purposes.

Systems using biometric identification techniques are known which make use of asymmetric or public/private key encryption to protect biometric scan data which is to be used in a transaction.

GB2348309A describes a system in which a biometric template is stored on a piece of hardware, either attached to an authentication device or carried by a user. This has the disadvantage of the user only being authenticated on a specific terminal, or having to carry around “proof” of their biometrics. In that case, the user might as well use a conventional hardware token. The authentication happens locally and not on a centralized database, so this patent is largely concerned with creating a unique secret key for each authentication.

US 2012/130904A1 describes the use of asymmetric public/private key encryption methods to secure the transmission of biometric information from a terminal having a biometric sensor to a secure registry.

It is an object of the invention to provide an alternative method and system for using biometric data securely in electronic transactions.

### SUMMARY OF THE INVENTION

In accordance with one aspect of the invention there is provided a system for securing the transmission of biometric data over an insecure network, the system including:
at least one transaction terminal including a user interface which is configured/arranged to receive personal identification information input by a user, a biometric scanner which is configured/arranged to read biometric data of the user, and a communication interface which is configured/arranged to transmit data to and receive data from a processing unit over an insecure network, the transaction terminal having a unique serial number and an associated unique private key;
a secure database for storing personal identification information and associated biometric templates of registered users, and the unique serial number and associated unique private key of said at least one transaction terminal; and
a processing unit which is operatively connected to the secure database,
wherein said at least one transaction terminal is operable to receive personal identification information via the user interface from a user participating in a transaction; to receive biometric data from the user via the biometric scanner; to generate a unique transaction code; to generate a hash of at least the received personal identification information, the received biometric data and the unique transaction code; to encrypt at least the hash using said unique private key; and to transmit the encrypted data over the insecure network to the processing unit for use in the transaction.

The term “processing unit” refers to a processor. More than one processor is described in the specification, and the term “processing unit” is used sometimes in order to help avoid confusion.

The at least one transaction terminal may include a processor and associated memory, the memory being configured/arranged to store the unique serial number and associated unique private key of the transaction terminal, and the processor being configured/arranged to generate the hash of at least the received personal identification information, the received biometric data and the unique transaction code, and to encrypt at least the hash using the unique private key. More specifically the memory may be a secure memory.

The processor may be configured/arranged to generate said hash from the received personal identification information, the received biometric data, the unique transaction code, and additionally from received vendor identification information and current time data relating to the transaction.

The processor may be configured/arranged to:
append further data to said hash, the further data including at least some of the data used to generate the hash; and
encrypt the hash and the appended further data.

The further data and the hash may therefore be combined so that the combination may be encrypted.

The further data may include all the data used to generate the hash.

The processing unit may be configured/arranged to:
receive the encrypted data transmitted by the transaction terminal;
decrypt the encrypted data by using the private key;
generate a hash of the further data; and
compare the generated hash of the further data with the hash included in the encrypted data transmitted by the transaction terminal, in order to determine whether or not they match.

The aim of the match is therefore to help check whether or not the integrity/accuracy of the transmitted data has possibly been compromised.

The processing unit may be configured/arranged to compare the biometric data included in the decrypted data to a biometric template stored on the database and which is associated with the personal identification information included in the decrypted data, in order to verify the identity of the user.

The user interface of said at least one transaction terminal may include a keyboard or keypad. The user interface may also include a display, more specifically a visual display (e.g. a touch screen).

The transaction may be a financial transaction.

The invention also extends to the transaction terminal itself, as described above. Therefore, in accordance with a further aspect of the invention there is provided a transaction device/terminal which includes:
a user interface which is configured/arranged to receive personal identification information input by a user;
a biometric scanner which is configured/arranged to read biometric data of the user;
a communication interface which is configured/arranged to transmit data to and receive data from a processing unit which is associated with a secure database over an insecure network, the transaction terminal having a unique serial number and an associated unique private key; and
a processor which is operable/configured to receive personal identification information via the user interface from a user participating in a transaction; to receive biometric data from the user via the biometric scanner; to generate a unique transaction code; to generate a hash of at least the received personal identification information, the received biometric data and the unique transaction code; to encrypt at least the hash using said unique private key; and to transmit the encrypted data to the processing unit via the communication interface.

The transaction terminal may include memory, the memory being configured/arranged to store the unique serial number and associated unique private key of the transaction terminal.

The processor may be configured/arranged to generate said hash from the received personal identification information, the received biometric data, the unique transaction code, and additionally from received vendor identification information and current time data relating to the transaction.

The processor may be configured/arranged to:
append further data to said hash, the further data including at least some of the data used to generate the hash; and
encrypt the hash and the appended further data.

The further data and the hash may therefore be combined so that the combination may be encrypted.

The further data may include all the data used to generate the hash.

In accordance with another aspect of the invention there is provided a method of securing the transmission of biometric data over an insecure network, the method including:
receiving encrypted data from at least one transaction terminal;
decrypting, by using a processor, the encrypted data using an associated unique private key, wherein the decrypted data includes a hash of at least personal identification information of a user, biometric data of the user and a transaction code.

The decrypted data may further include additional data to the hash, and the method may include:
generating, by using a processor, a hash of the said additional data; and
comparing, by using a processor, the generated hash with the hash included in the decrypted data in order to determine whether or not they match.

The aim of the match is therefore to help check whether or not the integrity/accuracy of the data received from the transaction terminal has possibly been compromised.

The method may further include, if it is determined that the generated hash and the hash included in the decrypted data match:
querying a database in order to retrieve a biometric template which is associated with the personal identification information included in the decrypted data; and
comparing, by using a processor, the biometric data included in the decrypted data with the biometric template in order to verify the identity of the user.

The decrypted data may relate to a transaction, and the method may further include, if it is determined that the generated hash and the hash included in the decrypted data match, querying a database in order to determine whether or not the transaction code has been used in a previous transaction.

The decrypted data may relate to a transaction, and the decrypted data may further include vendor identification information and current time data relating to the transaction. The current time data may therefore relate to the time, or at least the approximate time, at which the transaction was initiated at the transaction terminal (e.g. by a user).

The method may further include, if it is determined that the generated hash and the hash included in the decrypted data match, comparing, by using a processor, the said current time data with the actual current time and determining, by using a processor, whether or not a difference in time between the actual current time and a time indicated by the current time data falls within pre-determined limits. The actual current time may refer to the current time when the method is being performed. More specifically, the actual current time may refer to the time when it is determined that the generated hash and the hash included in the decrypted data match.

The transaction may be a financial transaction.

In accordance with yet a further aspect of the invention there is provided a method of securing the transmission of biometric data over an insecure network, the method including:
receiving personal identification information and biometric data of a user via a user interface and generating a unique transaction code by using a processor;
generating, by using a processor, a hash of at least the received personal identification information, the received biometric data and the transaction code;
encrypting, by using a processor, the hash using a unique private key; and
transmitting the encrypted data over the insecure network.

More specifically, the transmission of the encrypted data over the insecure network may be transmitted to a processing unit which is associated with a secure database. The processing unit may therefore be operatively connected to the secure database. The method may therefore include transmitting the encrypted data over the insecure network to the processing unit.

The encrypted data may be transmitted directly/indirectly to the processing unit (e.g. via a server).

The processor may be a microprocessor. Similarly, the processing unit may also be a microprocessor.

The method may include:
appending further data to the hash, by using a processor, wherein the further data includes the same data included in the hash; and
encrypting the hash and the appended data using the unique private key, by using a processor.

The further data and the hash may therefore be combined so that the combination of data may be encrypted.

The method may include, after transmitting the encrypted data to the processing unit, receiving encrypted data from the processing unit and decrypting, by using a processor, the encrypted data received from the processing unit by using an associated unique private key. The encrypted data may be received directly or indirectly from the processing unit.

The decrypted data may include a hash of information of at least one bank account which is associated with the user, as well as additional data to the hash, and the method may further include:
generating, by using a processor, a hash of the said additional data; and
comparing, by using a processor, the generated hash with the hash included in the decrypted data in order to determine whether or not they match, wherein a match indicates that the additional data corresponds with the data of the hash which is included in the decrypted data.

The aim of the match is therefore to help check whether or not the integrity/accuracy of the data received from the processing unit has possibly been compromised.

The method may further include, if it is determined that the generated hash and the hash included in the decrypted data match, sending at least some of the information of the at least one bank account which is associated with the user to the user interface.

The decrypted data may include current time data relating to a transaction, and the method may further include:
comparing, using a processor, the time indicated by the said current time data with the actual current time; and
determining, using a processor, whether or not a difference in time between the actual current time and the time indicated by the current time data falls within pre-determined limits.

The current time data may therefore relate to the time, or at least the approximate time, at which the encrypted data, which was received from the processing unit, was created/prepared by the processing unit.

The actual current time may refer to the current time when the method is being performed. More specifically, the actual current time may refer to the time when it is determined that the generated hash and the hash included in the decrypted data match.

The biometric scanner may be, in a preferred example embodiment, a camera arranged to scan a characteristic of the user, such as a fingerprint or a palm vein pattern.

The transaction may be a financial transaction.

The methods described above may also specifically be for securing the transmission of biometric data over an insecure network during a financial transaction.

The methods described above may also be for facilitating the secure transmission of biometric data over an insecure network during a financial transaction.

The methods described above may also relate to a method of sending biometric data over an insecure network and a method of retrieving biometric data which was received via an insecure network.

### BRIEF DESCRIPTION OF THE DRAWINGS

FIG. 1 is a simplified block schematic diagram showing a system for securing the transmission of biometric data over an insecure network according to an example embodiment of the invention;

FIG. 2 is a simplified flow chart showing major steps in a method of carrying out a transaction according to an example embodiment of the invention;

FIG. 3 is a simplified flow chart showing major steps carried out by the transaction terminal in carrying out a transaction;

FIG. 4 is a diagrammatic representation of a session data packet sent by the transaction terminal to a processor of a user terminal which is operatively connected to a secure database;

FIG. 5 is a simplified flow chart showing major steps carried out by the processor of the user terminal, in response to the receipt of data from the transaction terminal;

FIG. 6 is a diagrammatic representation of a session data packet sent by the processor of the user terminal to the transaction terminal in the event of a successful process;

FIG. 7 is a diagrammatic representation of a session data packet sent by the processor of the user terminal to the transaction terminal in the event of an unsuccessful process;

FIG. 8 is a simplified flow chart showing major steps carried out by the processor of the user terminal in a self-monitoring procedure performed from time to time;

FIG. 9 is a diagrammatic representation of a log request packet sent by the processor of the user terminal to the transaction terminal;

FIG. 10 is a diagrammatic representation of a log output packet sent by the transaction terminal to the secure database via the processor of the user terminal; and

FIG. 11 is a simplified flow chart showing major steps carried out by the transaction terminal in generating the log output packet.

### DESCRIPTION OF EMBODIMENTS

In the following description, for purposes of explanation, numerous specific details are set forth in order to provide a thorough understanding of an embodiment of the present invention. It will be evident, however, to one skilled in the art that the present invention may be practiced without these specific details.

Essentially, the invention provides a method and system for securing the transmission of biometric data over an open and potentially insecure network (such as the Internet). This allows a biometric template to be stored in a secure central database while permitting other remote devices to grant or deny access to information from different physical locations.

More particularly, the invention provides a method and system for carrying out transactions securely. The system includes a secure central database and a number of transaction terminals or devices which have unique serial numbers and are registered with the system. Each terminal stores a unique private key in secure memory, and that same key is stored in the secure database, associated with the terminal's serial number.

The method and system use an algorithm which ensures that the secure database only receives verified usable information from each of the registered terminals so that a malicious third party is unable to “steal” or replicate any biometric data or information that can be used to fool the database, even if the third party has installed “man in the middle” malware or is able to access the packets of data transmitted between the terminals and the database.

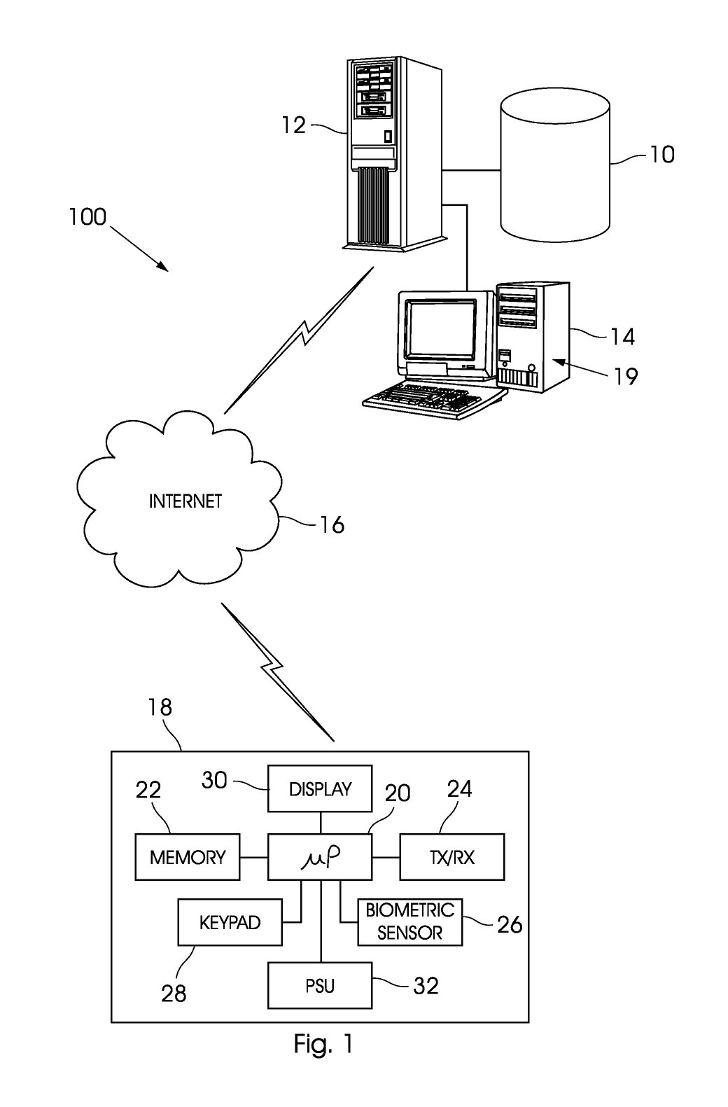

Referring now to FIG. 1 of the drawings, a secure database 10 and a transaction terminal 18 forming part of the system 100 described above are shown schematically.

The secure database 10 is located at a secure location (e.g. a data centre) and has an associated server 12 and a local user terminal 14 for administration of the database 10. The user terminal 14 includes a processor or processing unit in the form of a microprocessor (generally indicated by reference numeral 19). The server 12 has a communication interface allowing it to communicate via the Internet or another network 16.

The transaction terminal 18 is shown in block schematic form and includes a microprocessor 20 with associated secure memory 22, and a communication interface 24 such as an Ethernet card or other data transmission means. The terminal 18 further includes a biometric sensor/scanner 26, and a user interface comprising a keypad or keyboard 28 and a display 30 (e.g. an LCD/LED screen). The unit includes a power supply unit 32, which may include batteries and/or a mains PSU. In the described embodiment, the biometric scanner 26 is an infra-red camera which images a user's palm, but any suitable biometric scanner could be used, such as a fingerprint or iris scanner.

The secure database 10 stores personal and biometric information of users who enroll or register with the system 100. The personal information will typically include the user's name and contact details, and details of one or more bank accounts or credit card accounts). The biometric information will be a template derived from a reference biometric scan which is stored in the secure database 10 and used as reference when biometric scan data of the user is received from transaction terminals 18.

Each transaction terminal 18 stores a private key and a terminal serial number 400. The private key (PK) and terminal serial number 400 are unique to each device/terminal 18. The database 10 stores the serial number of each terminal 18 and the private key that corresponds to it.

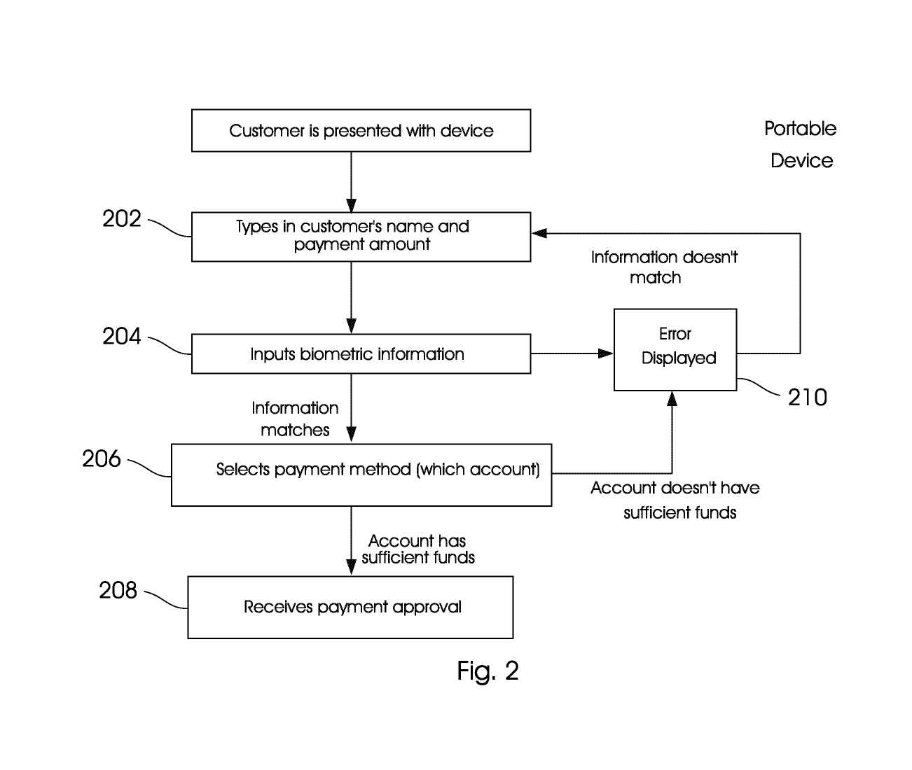

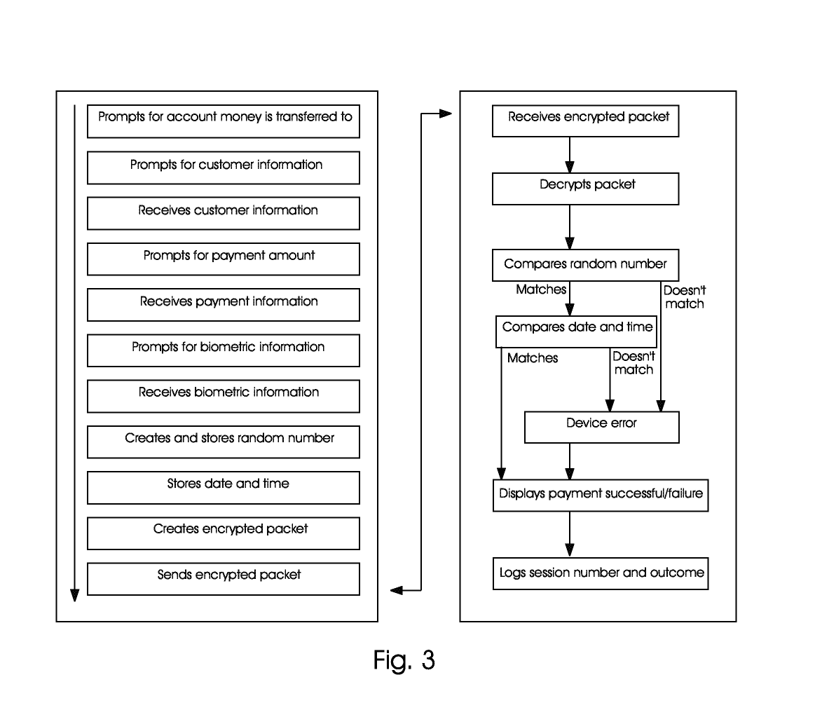

When a customer who has enrolled in the system 100 wishes to make a purchase (or perform another transaction that requires identification) at a location where a terminal 18 of the system 100 is available, they use the keypad 28 to type in their name, and optionally other personal information, as well as information relating to the transaction (such as the transaction amount—for example, the amount of the bill at a restaurant) (see block 202 in FIG. 2). The terminal 18 then prompts the customer for their biometric data (at block 204), which is obtained using the scanner 26. The process from the user's point of view is summarized in the flow chart of FIG. 2, while the internal processes of the terminal 18 are summarized in the flow chart of FIG. 3.

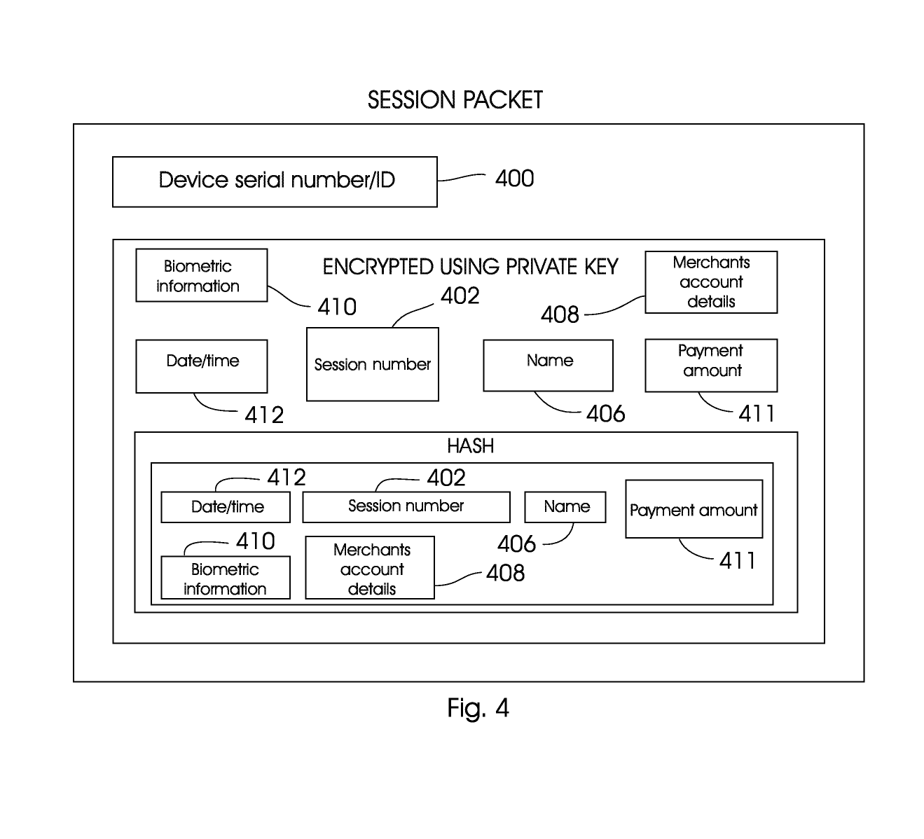

Referring now also to FIG. 4, the terminal creates a unique transaction number/code or session number 402 and stores this number in its own internal memory 22. The terminal/device 18 takes the customer's name 406, the account details 408 of the restaurant or other merchant, the payment amount 411, the customer's biometric information/data 410, the unique session number 402 (referred to above) and the current time 412 (i.e. the transaction time, which may typically also include the current date) and applies a hashing function to the amalgamation of all this data. The terminal then appends the same data to which the hashing function was applied (i.e. the customer's name 406, the account details 408 of the restaurant or other merchant, the payment amount 411, the customer's biometric information 410, the unique session number 402 and the transaction time 412) to the resulting hash and encrypts all the data using the pre-determined private key, as indicated in FIG. 4.

The terminal 18 appends its own serial number 400 (which may or may not be the ip address of the device/terminal 18) to the encrypted data, and submits a session packet comprising this encrypted data and serial number 400 over the network 16 to the user terminal 14.

The hash function employed can be any suitably secure one as long as it is the same one each time. In the prototype system the MD5 hash was used for convenience. Alternatively, the hashing algorithm SHA3 may be used, which may provide better security.

The encryption used in the prototype system is AES (Rijndael) 256 bit symmetric encryption. However, asymmetric encryption methods would work too, as would other private key algorithms.

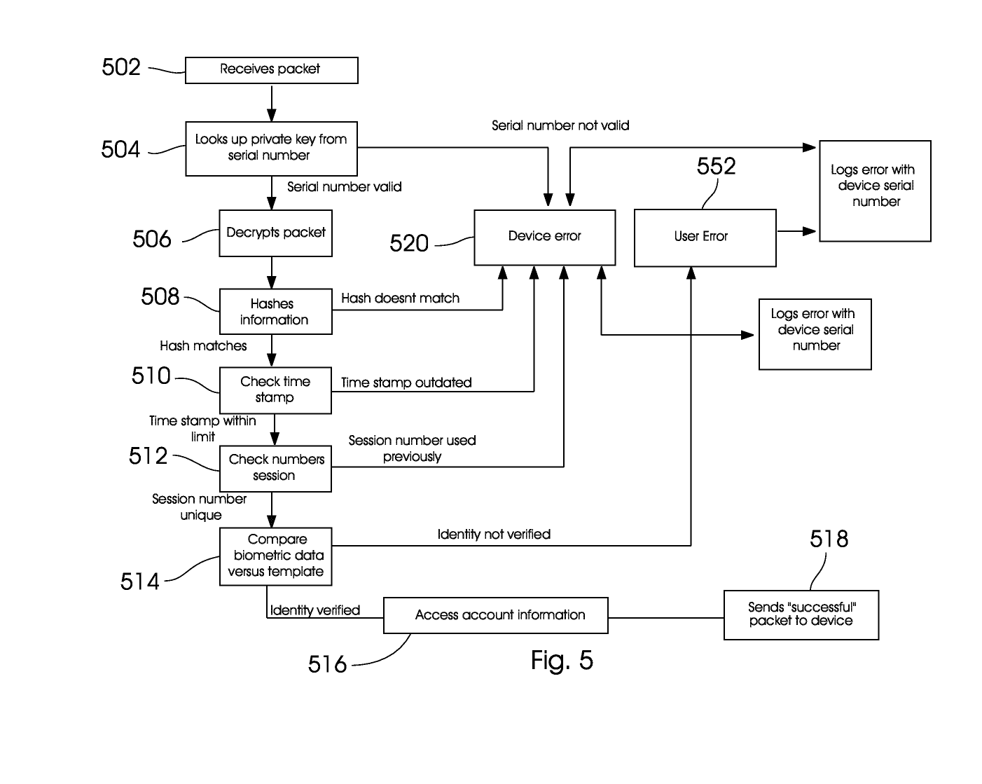

The process followed by the microprocessor 19 of the user terminal 14 is shown in the flow chart of FIG. 5. The microprocessor 19 receives the session packet (at block 502) and identifies the relevant private key used (which is stored on the database 10) from the terminal serial number 400 (at block 504). The microprocessor 19 decrypts the packet using the private key (at block 506).

Once the session packet has been decrypted the microprocessor 19 creates a hash (at block 508) of the data appended to the hash in the session packet (i.e. the customer's name 406, the account details 408 of the restaurant or other merchant, the payment amount 411, the customer's biometric information 410, the unique session number 402 and the transaction time 412) and compares this to the received hash to see if they match up. If they match up, the microprocessor 19 compares the submitted transaction time 412 with the current time (at block 510) to see if it falls within pre-determined limits, and searches the database 10 to see whether the session number 402 has been used by the device/terminal 18 before (at block 512). The pre-determined limit may, for instance, specify that the difference in time between the submitted transaction time 412 and the current time be less than 2 minutes.

If all these checks are passed, the microprocessor 19 compares the biometric information/data 410 in the transmitted session packet with the biometric template stored for that person in the database 10, to verify the customer's identity (at block 514).

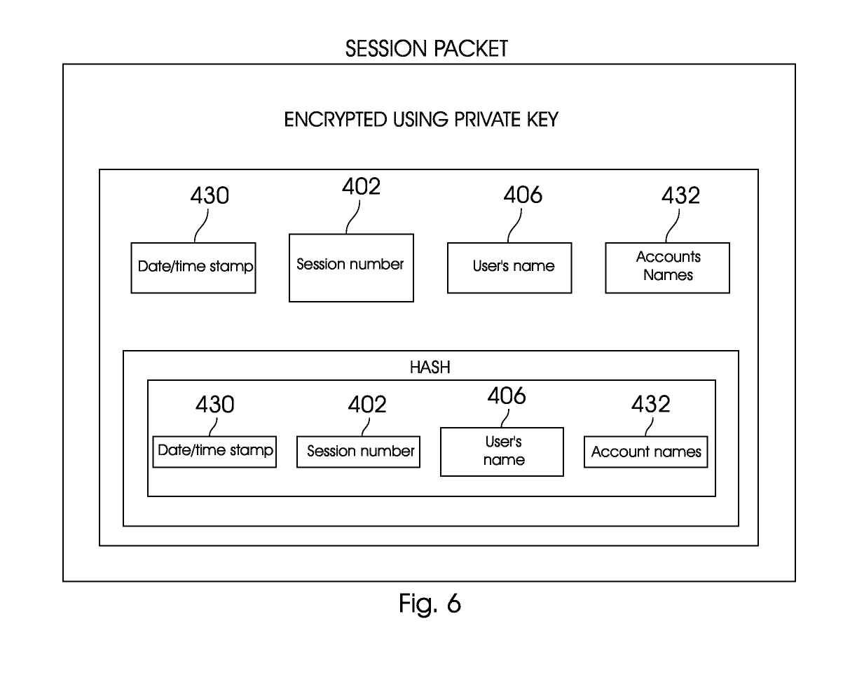

Referring now to both FIGS. 5 and 6, the microprocessor 19 then extracts the relevant information from the customer's stored profile (at block 516) on the database 10 (such as details of the customer's available bank accounts 432), appends it to the current time 430, the customer's name 406 and the session number 402, creates a hash of this data and appends the hash onto the data itself (in a similar manner as described above), then encrypts it all using the private key and sends it back to the terminal 18 (at block 518). The format of the successful session data packet sent by the microprocessor 19 is shown in FIG. 6.

The terminal 18 receives the encrypted data in the session packet of FIG. 6 and uses its private key to decrypt it. It creates a hash of the account information 432, time information 430, customer's name 406 and the session number 402 and compares this hash to the hash submitted. The terminal 18 also compares the time information 430 submitted with the current local time to see if it falls within the permitted time frame and then makes sure that the session number 402 received is the same as the last transaction number sent.

The terminal 18 displays the available bank accounts on the display 30 and the customer uses the keypad 28 to select the bank account he/she would like to use (see block 206 in FIG. 2).

The terminal 18 takes the bank account selected, the session number 402, the current time and a random (or pseudorandom) number and appends all this information together. It also stores the random number in the internal memory 22. It then creates a hash of this data and appends the same data to which the hashing function was applied to this hash. It then encrypts all of this data using the private key and sends the encrypted data and its own serial number 400 to the microprocessor 19.

The microprocessor 19 receives this, decrypts it with the private key, creates a hash of the appended data and compares it with the hash sent in order to see it they match. It then checks to see that the selected bank account is valid and has sufficient funds (by querying the database 10), and that the time sent is within limits. It stores the bank account used as well as the random number sent with the session number 402 in the database 10.

If the selected account does have sufficient funds, the microprocessor 19 creates a “transaction complete” message which contains the current time, the random number previously generated, and the fact that the transaction was successful, as well as the hash of all this data, encrypts it using the private key and sends it to the terminal 18.

The terminal 18 decrypts this data, creates its own hash (in a similar matter as described above) and compares it to the received hash, compares the received and local time, and compares the received random number with the one saved. It displays the fact that the transaction was successful for the customer to see (i.e. on the display 30) (at block 208 (see FIG. 2) and saves the information related to the transaction (i.e. session number 402, random number generated, name of customer, time of transaction, amount of transaction, bank account used and failure/success of the transaction).

In a similar fashion, if the selected account does not have sufficient funds, the microprocessor 19 creates an error message which is sent (in the same way as described above) and displayed to the customer on the display 30 (at block 210 (see FIG. 2)).

The terminal 18 then creates a “displayed information” message to be sent back to the microprocessor 19 which consists of the random number previously generated, the current time, and data to say/indicate that the information was displayed on the display 30, as well as a hash of this info. It encrypts this and sends it to the microprocessor 19 with the serial number 400.

Once again the microprocessor 19 decrypts the received data, compares the hash and time information and then saves the fact that the transaction was displayed to the customer in the database 10 and contacts the bank to do the transaction.

At the end of the day (or other pre-determined time period) the microprocessor 19 (together with the database 10) checks that everything is in order, it creates a random number and the current time and a hash of this and a command that the terminal 18 understands to list the transactions, encrypts it and sends it to the terminal 18.

The terminal 18 decrypts the command, checks the hash and time information and then appends all the transaction numbers of the day with their respective statuses as well as with the random number sent, creates a hash of it and encrypts it, and sends it back to the microprocessor 19.

The microprocessor 19 decrypts this message, checks that the hash and random number match up and then compares the status information of all the transactions sent with those stored (in the database 10) to make sure they have been processed.

There are different ways in which the microprocessor 19 knows which account to transfer funds to. A first method is to have the customer (or some other user such as the waiter) type in the account details prior to typing in the customer's name and sending this data in a similar manner to the other data as described above. Another way is to have the terminal/device 18 registered to the recipient's account so that all transactions on that device are associated with that account and the monies are transferred to that account by default. (This would require the device to be registered prior to it being usable, similar to enrollment of users with the system.)

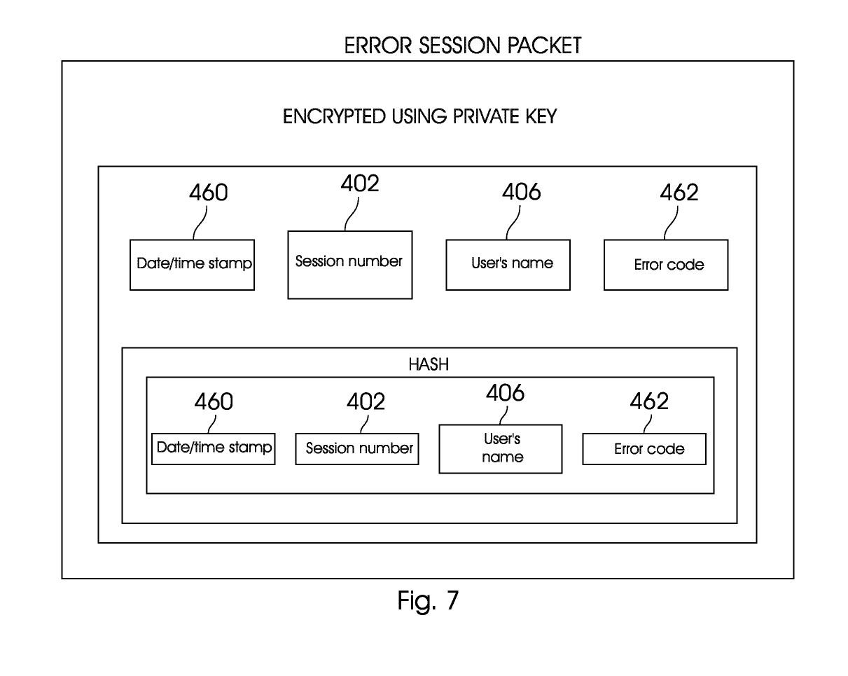

FIG. 7 shows an error session packet, which is similar in format to the other session packets described above) that the microprocessor 19 sends to the terminal or device 18 (see block 210 in FIG. 2 as well as blocks 520 and 522 in FIG. 5) in the case that there is a problem, e.g. the biometric scan doesn't match the associated name (see block 514 in FIG. 5); there is an error with the hash (see block 508 in FIG. 5); the submitted time is outdated (i.e. the time difference between the submitted time and the current time falls outside pre-determined limits) (see block 510 in FIG. 5); the session number 402 has been used by the device/terminal 18 before (see block 512 in FIG. 5); the serial number 400 is not valid (see block 504 of FIG. 5); or there are insufficient funds in the selected account (see block 210 in FIG. 2). The error session packet typically includes the current/transaction time 460, the session number 402, the customer's name 406 and an error code 462 which represents which error occurred (as well as a hash of this information).

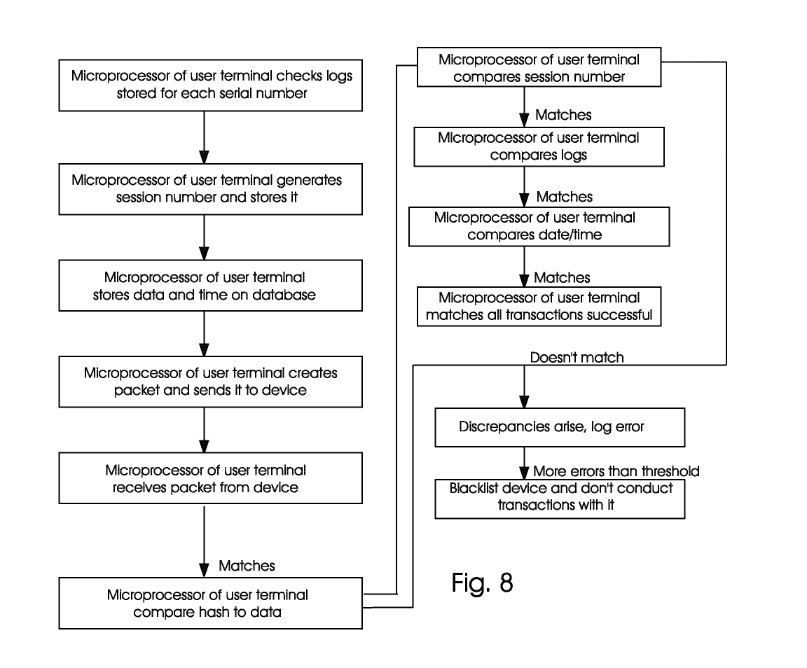

FIG. 8 shows the steps that the microprocessor 19 carries out in order to check that everything is in order with all of the terminals/devices 18. This is in part to see whether any of the terminals/devices 18 have been tampered with or anyone is trying to cheat the system. If there is evidence of this, the device 18 will be blacklisted. This process is not done for every transaction but rather after some set amount of time. The ability to detect tampering and then blacklist or disable an affected device 18 to prevent information from being gleaned from the system 100 by an unauthorized person is one of the major advantages of the described system 100.

Blacklisting can be done in several ways. For example, the serial number PK pair can be deleted from the database 10, preventing the device 18 from working. Alternatively (or additionally) the microprocessor 19 could send instructions to the device 18 instructing it to wipe its memory.

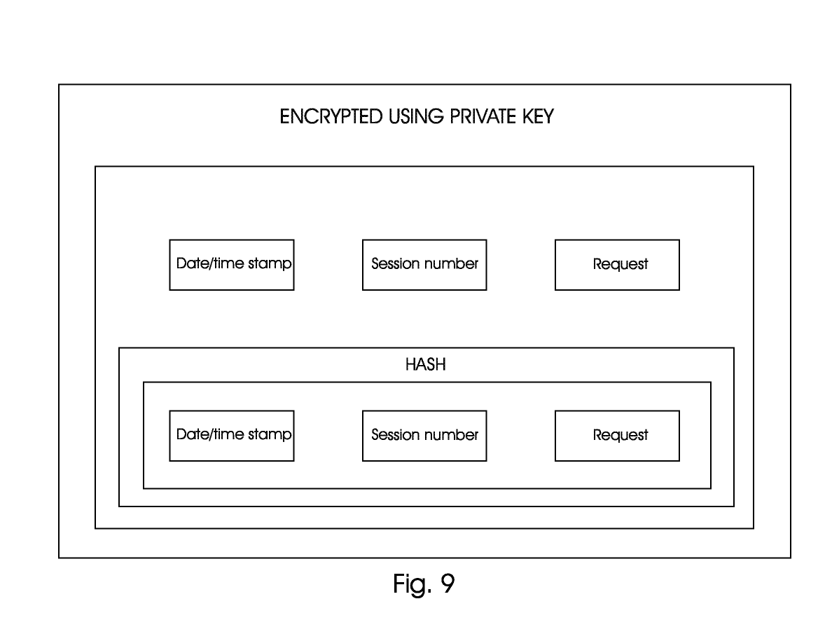

FIG. 9 illustrates a data packet that the microprocessor 19 sends to the terminal/device 18, corresponding to step 4 of FIG. 8.

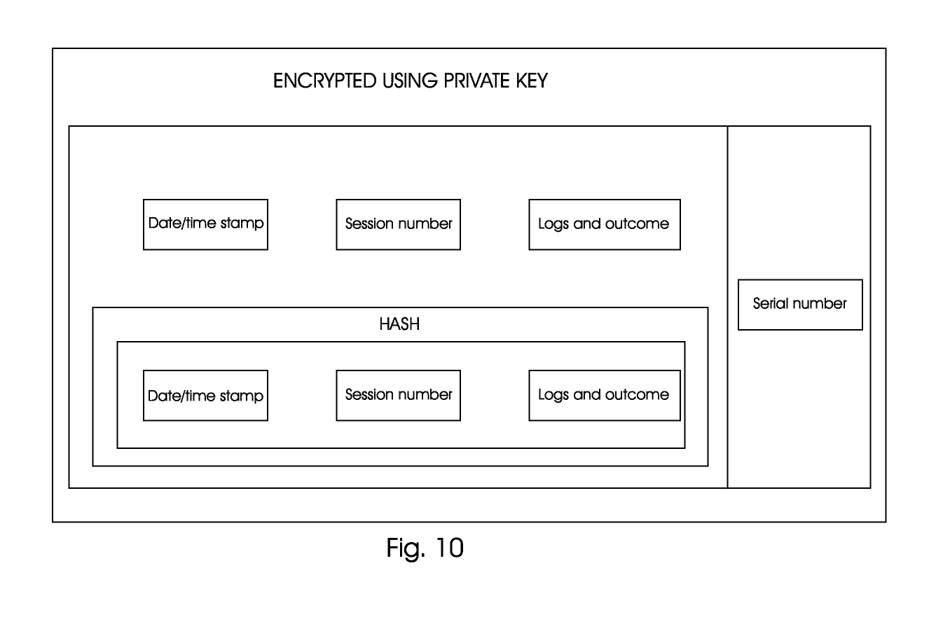

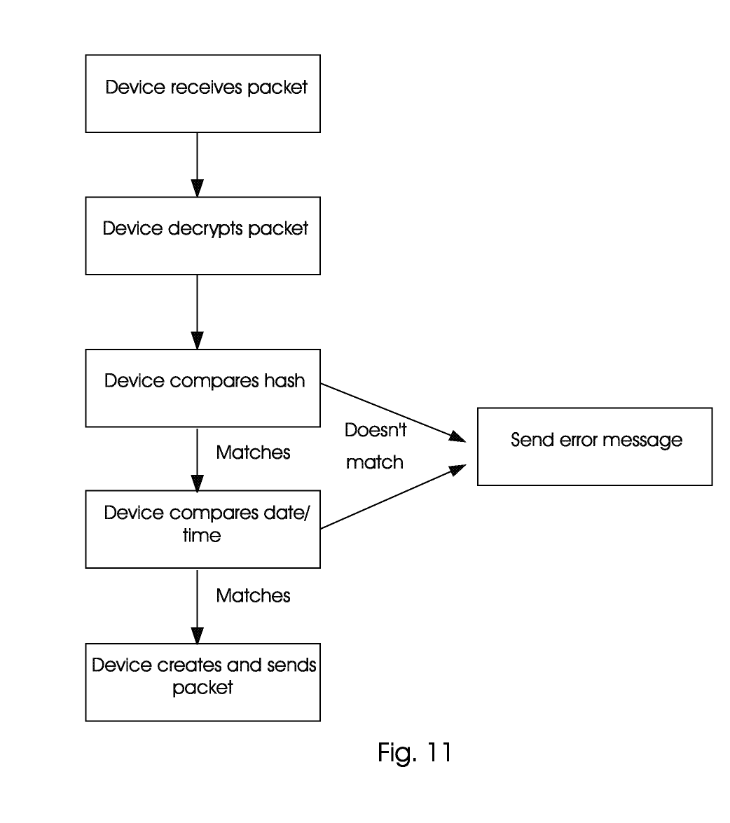

FIG. 10 shows the data packet that the device 18 sends to the microprocessor 19, in accordance with step 5 of FIG. 11. This is the response to the “request for logs” procedure shown in FIG. 8.

Finally, FIG. 11 shows the steps taken by the device in response to receipt of the data packet of FIG. 9.

Various applications for the method and system 100 of the invention are possible. For example, restaurants or shops can be provided with terminals 18 as described to enable customers to pay for their purchases using biometric data which is unique to them, without needing to use cash or credit cards.

Another application is to have the terminals 18 at user's computers to allow them to access their banking information or other sensitive data such as company e-mails.

By using the above described secure procedures, transactions can be conducted securely over an inherently insecure medium such as the Internet, using biometric data for user identification.

The invention addresses the problem of needing hardware and information (such as credit card, tokens, usernames or PINs) in order to access private information via the Internet, for example, to access one's bank account in order to transfer money, with a robust and secure method and system.

It is believed that a novel aspect of the invention is the use of encrypted hashes of the data transmitted between the microprocessor 19 (together with the secure database 10) and the transaction terminal 18, as well as several one-time data points (such as the transaction number) in order to make the data of each message unique. This means that a copied data packet is no longer valid and it is difficult to change even small bits of data without compromising the entire packet (if a bit of the data is changed the hash will no longer match up). This is done without the use of public key encryption (or asymmetric encryption), and is believed to offer enhanced security.

Unlike known systems using asymmetric encryption which create a unique secret key for each authentication, the system of the present invention uses the same private key for every authentication on a specific device.

Asymmetric encryption was not used in the above described method and system (unlike the majority of similar systems) due to the security flaws inherent in such encryption. Recently a flaw was revealed in many of the prime number generators used in such encryption systems, thereby compromising about a quarter of the keys. Flaws in the generation system are still being found and use of such a system would require a recall of all the affected devices every time a new flaw was discovered. It is also believed that the longevity of this form of asymmetric encryption is doubtful, as the advent of quantum computers or even more powerful regular computers can compromise the codes, whereas the type of encryption used in the present invention does not have the same vulnerabilities.

1. A system for securing the transmission of biometric data over an insecure network, the system including:
at least one transaction terminal including a user interface which is configured to receive personal identification information input by a user, a biometric scanner which is configured to read biometric data of the user, and a communication interface which is configured to transmit data to and receive data from a processing unit over an insecure network, the transaction terminal having a unique serial number and an associated unique private key;
a secure database for storing personal identification information and associated biometric templates of registered users, and the unique serial number and associated unique private key of said at least one transaction terminal; and
a processing unit which is operatively connected to the secure database,
wherein said at least one transaction terminal is operable to receive personal identification information via the user interface from a user participating in a transaction; to receive biometric data from the user via the biometric scanner; to generate a unique transaction code; to generate a hash of at least the received personal identification information, the received biometric data and the unique transaction code; to encrypt at least the hash using said unique private key; and to transmit the encrypted data over the insecure network to the processing unit for use in the transaction.

2. The system of claim 1, wherein the at least one transaction terminal includes a processor and associated secure memory, the memory being configured to store the unique serial number and associated unique private key of the transaction terminal, and the processor being configured to generate the hash of at least the received personal identification information, the received biometric data and the unique transaction code, and to encrypt at least the hash using the unique private key.

3. The system of claim 2, wherein the processor is configured to generate said hash from the received personal identification information, the received biometric data, the unique transaction code, and additionally from received vendor identification information and current time data relating to the transaction.

4. The system of claim 1, wherein the processor is configured to:
append further data to said hash, the further data including at least some of the data used to generate the hash; and
encrypt the hash and the appended further data.

5. The system of claim 4, wherein the further data includes all the data used to generate the hash.

6. The system of claim 5, wherein the processing unit is configured to:
receive the encrypted data transmitted by the transaction terminal;
decrypt the encrypted data by using the private key;
generate a hash of the further data; and
compare the generated hash of the further data with the hash included in the encrypted data transmitted by the transaction terminal, in order to determine whether or not they match.

7. The system of claim 6, wherein the processing unit is configured to compare the biometric data included in the decrypted data to a biometric template stored on the database and which is associated with the personal identification information included in the decrypted data, in order to verify the identity of the user.

8. The system of claim 1, wherein the user interface of said at least one transaction terminal includes:
a keyboard or keypad; and
a display.

9. A method of securing the transmission of biometric data over an insecure network, the method including:
receiving encrypted data from at least one transaction terminal; and
decrypting, by using a processor, the encrypted data using an associated unique private key, wherein the decrypted data includes a hash of at least personal identification information of a user, biometric data of the user and a transaction code.

10. The method of claim 9, wherein the decrypted data further includes additional data to the hash, and wherein the method includes:
generating, by using a processor, a hash of the said additional data; and
comparing, by using a processor, the generated hash with the hash included in the decrypted data in order to determine whether or not they match.

11. The method of claim 10, which further includes, if it is determined that the generated hash and the hash included in the decrypted data match:
querying a database in order to retrieve a biometric template which is associated with the personal identification information included in the decrypted data; and
comparing, by using a processor, the biometric data included in the decrypted data with the biometric template in order to verify the identity of the user.

12. The method of claim 10, wherein the decrypted data relates to a transaction, and the method further includes, if it is determined that the generated hash and the hash included in the decrypted data match, querying a database in order to determine whether or not the transaction code has been used in a previous transaction.

13. The method of claim 10, wherein the decrypted data relates to a transaction, and the decrypted data further includes vendor identification information and current time data relating to the transaction.

14. The method of claim 13, wherein the method further includes, if it is determined that the generated hash and the hash included in the decrypted data match, comparing, by using a processor, the said current time data with the actual current time and determining, by using a processor, whether or not a difference in time between the actual current time and a time indicated by the current time data falls within pre-determined limits.

15. A method of securing the transmission of biometric data over an insecure network, the method including:
receiving personal identification information and biometric data of a user via a user interface and generating a unique transaction code by using a processor;
generating, by using a processor, a hash of at least the received personal identification information, the received biometric data and the transaction code;
encrypting, by using a processor, the hash using a unique private key; and
transmitting the encrypted data over the insecure network.

16. The method of claim 15, wherein the transmission of the encrypted data over the insecure network is transmitted to a processing unit which is associated with a secure database, and the method therefore includes transmitting the encrypted data over the insecure network to the processing unit.

17. The method of claim 16, which includes:
appending further data to the hash, by using a processor, wherein the further data includes the same data included in the hash; and
encrypting the hash and the appended data using the unique private key, by using a processor.

18. The method of claim 17, which includes, after transmitting the encrypted data to the processing unit, receiving encrypted data from the processing unit and decrypting, by using a processor, the encrypted data received from the processing unit by using an associated unique private key.

19. The method of claim 18, wherein the decrypted data includes a hash of information of at least one bank account which is associated with the user, as well as additional data to the hash, and wherein the method further includes:
generating, by using a processor, a hash of the said additional data; and
comparing, by using a processor, the generated hash with the hash included in the decrypted data in order to determine whether or not they match, wherein a match indicates that the additional data corresponds with the data of the hash which is included in the decrypted data.

20. A transaction terminal which includes:
a user interface which is configured to receive personal identification information input by a user;
a biometric scanner which is configured/arranged to read biometric data of the user;
a communication interface which is configured to transmit data to and receive data from a processing unit which is associated with a secure database over an insecure network, the transaction terminal having a unique serial number and an associated unique private key; and
a processor which is configured to receive personal identification information via the user interface from a user participating in a transaction; to receive biometric data from the user via the biometric scanner; to generate a unique transaction code; to generate a hash of at least the received personal identification information, the received biometric data and the unique transaction code; to encrypt at least the hash using said unique private key; and to transmit the encrypted data to the processing unit via the communication interface.
